(19) United States
(12) Patent Application Publication
(10) Pub. No.: US 2015/0273785 A1
(43) Pub. Date: Oct. 1, 2015

(54) BLACK MATRIX STRENGTHENING STRUCTURE OF GLASS SUBSTRATE

(71) Applicant: GHITRON TECHNOLOGY CO., LTD., HSINCHU (TW)

(72) Inventor: CHUN-YUAN LEE, HSINCHU (TW)

(21) Appl. No.: 14/659,894

(22) Filed: Mar. 17, 2015

(30) Foreign Application Priority Data
Mar. 28, 2014 (TW) 103111594

(51) Int. Cl. B32B 3/02; B32B 17/06

(52) U.S. Cl. CPC B32B 3/02; B32B 17/064; B32B 2457/208

(57) ABSTRACT

Disclosed is a black matrix strengthening structure for a glass substrate. The black matrix is formed on a surface of the glass substrate. After an edge of the glass substrate has been subjected to etching, a recessed portion is formed in the edge of the glass substrate and the black matrix forms a suspending section at a location corresponding to the recessed portion. A structure support section is filled up in the recessed portion to help support and hold the suspending section of the black matrix in position.

### BACKGROUND OF THE INVENTION

1. Field of the Invention

The present invention relates to a black matrix structure of a glass substrate, and in particular to a black matrix strengthening structure for a glass substrate, which comprises a structure support section formed on an edge of a glass touch panel or a glass panel of a screen to support and hold a black matrix of the glass substrate.

2. The Related Arts

A conventional capacitive touch panel is generally composed of a two-layered arrangement of an upper transparent substrate and a lower transparent substrate of glass or resin and touch circuits are provided on the surfaces of the upper transparent substrate and the lower transparent substrate, wherein the upper transparent substrate is associated with X-axis touch wires, while the lower transparent substrate is associated with Y-axis touch wires. The X-axis touch circuits and the Y-axis touch wires are arranged to be mutually perpendicular to each other. Further, the upper transparent substrate and the lower transparent substrate are each provided on a peripheral edge with a black matrix to shield conductive wires, whereby when a user touches a surface of the touch panel with a finger or a conductive object, variation of capacitance occurring at the touch point can be detected and converted into the X-axis and Y-axis coordinates of the touch point that are then supplied to and displayed on a screen.

With the increasing demand of the consumer market for the outside appearance of electronic products being thin and light, a one-glass-solution (OGS) touch panel that is manufactured with a process that reduces one transparent substrate and makes the X-axis and Y-axis touch wires and a back matrix directly on a single glass substrate has been favored and widely used by the electronic product manufacturers or the brand-named manufacturers because it may greatly reduce the thickness of a final product of a touch panel and reduces the space required for the assembly of an electronic product can be reduced thereby satisfying the need for making the outside appearance of an electronic product lighter and thinner and suiting the needs of the market.

However, the conventional OGS touch panel manufacturing processes still suffer various problems. For example, after certain precedent steps of the manufacturing process of a glass substrate, including layout of touch wires and black matrixes, cutting, edge polishing, and drilling, an etch-strengthening process is conducted on an edge of the glass substrate. During such an etching process, it is common to attach a lamination film on upper and lower surfaces of the glass substrate. Such lamination films provide an effect of resistance against strong acids and alkalis to allow the glass substrate to be dipped in a corrosive solution to conduct etching of the edge of the glass substrate, whereby micro cracks and irregularities are removed by being etched off in a chemical way.

Although the etching process provides a better result than physical polishing, the edge of the glass substrate, which is subjected to such etching, often makes a portion of an edge of a black matrix exposed due to the edge of the glass substrate being partly hollowed to form a recessed portion, whereby a portion of the black matrix that corresponds to such a recessed portion becomes a suspending section. Such a condition often leads to deficiencies of the black matrix, including deformation of structure, insufficient support, incapable of effectively maintaining a horizontal position. In a subsequent film peeling process, the black matrix may get deformed and detached along with the lower lamination film or separation of the black matrix may occur in a subsequent production process or after a long term of use.

Besides such structural drawbacks being found in the currently widely used glass touch panels, glass panel used in screen may also suffer such structural drawbacks.

### SUMMARY OF THE INVENTION

In view of the above drawbacks of the manufacture of a conventional touch panel, a primary object of the present invention is to provide a black matrix strengthening structure of a glass touch panel in order to provide an effect of supporting and stabilizing the black matrix of the glass touch panel.

Another object of the present invention is to provide a black matrix strengthening structure for a glass panel of a screen in order to provide an effect of supporting and stabilizing the black matrix of the glass panel.

To achieve the above objects, the technical solution of the present invention is forming a structure support section at an edge of a glass substrate in such a way that the substrate support section fills up a recessed portion formed between the edge of the glass substrate and a black matrix in order to support and hold a suspending section of the black matrix in position. The glass substrate can be a glass touch panel or a glass panel of a screen.

The structure support section can be made of a material selected from one of acrylic glue, silicone, polyurethane glue, and thermosetting glue.

The glass substrate is formed of one of transparent glass and transparent plastics.

An operation surface of the glass substrate comprises an upper lamination film attached thereto.

A circuit layout surface of the glass substrate comprises a lower lamination film attached thereto.

With the structure support section according to the present invention, the black matrix of a glass touch panel or a glass panel of a screen can be effectively protected against potential risks of deformation, peeling, and damage. Further, in peeling off an upper lamination film and a lower lamination film after the completion of an etching operation, due to the structure support section being filled up in a recessed portion between an edge of a glass substrate and the black matrix, a suspending section of the black matrix can be securely supported and held in position through adhesion.

### BRIEF DESCRIPTION OF THE DRAWINGS

The present invention will be apparent to those skilled in the art by reading the following description of preferred embodiments of the present invention, with reference to the attached drawings, in which:

FIG. 1 is a perspective view showing a first embodiment according to the present invention applied to a glass touch panel;

FIG. 2 is a cross-sectional view taken along line 2-2 of FIG. 1;

FIG. 3 is across-sectional view showing, in the first embodiment of the present invention, an upper lamination film and a lower lamination film respectively attached to an operation surface and a circuit layout surface of a glass substrate;

FIG. 4 is across-sectional view showing, in the first embodiment of the present invention, an edge of the glass substrate after being etched;

FIG. 5 is a cross-sectional view showing, in a first embodiment of the present invention, a structure support section formed on the edge of the glass substrate;

FIG. 6 is a cross-sectional view showing the upper lamination film and the lower lamination film of FIG. 5 removed from the operation surface and the circuit layout surface of the glass substrate;

FIG. 7 is a perspective view showing a second embodiment according to the present invention applied to a glass panel of a screen;

FIG. 8 is a cross-sectional view taken along line 8-8 of FIG. 7;

FIG. 9 is a cross-sectional view showing, in the second embodiment of the present invention, an upper lamination film and a lower lamination film respectively attached to a first surface and a second surface of a glass substrate;

FIG. 10 is a cross-sectional view showing, in the second embodiment of the present invention, an edge of the glass substrate after being etched;

FIG. 11 is a cross-sectional view showing, in a second embodiment of the present invention, a structure support section formed on the edge of the glass substrate; and

FIG. 12 is a cross-sectional view showing the upper lamination film and the lower lamination film of FIG. 11 removed from the first surface and the second surface of the glass substrate.

### DETAILED DESCRIPTION OF THE PREFERRED EMBODIMENTS

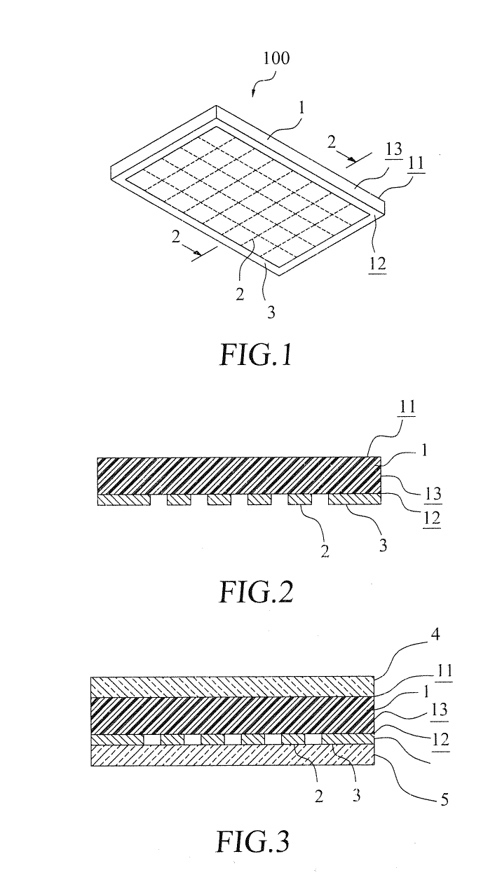

Referring to FIG. 1, a perspective view is given to illustrate a first embodiment of the present invention that is applicable to a glass touch panel 100. FIG. 2 shows a cross-sectional view taken along line 2-2 of FIG. 1. According to the present invention, a glass substrate 1 is first prepared and provided. The glass substrate 1 comprises an operation surface 11 and a circuit layout surface 12, of which the operation surface 11 serves as a surface on which operations conducted by a user may be performed, when the present invention is applied to a touch panel.

Before subsequent operations of the manufacturing process proceeds, the glass substrate 1 is first subjected to a strengthening treatment, such as any known chemical or physical strengthening processes, in order to increase the hardness of the glass substrate 1.

A touch circuit 2 and a black matrix 3 corresponding to the touch circuit 2 are laid on the circuit layout surface 12 of the glass substrate 1 in such a way that an outer edge of the black matrix 3 is substantially aligned with an edge 13 of the glass substrate 1. The cross-sectional view of FIG. 2 illustrates a condition where the touch circuit 2 and the black matrix 3 have been completed on the circuit layout surface 12 of the glass substrate 1. The black matrix 3 can alternatively be of any other colors (such as white or other colors), and the material that makes the black matrix 3 can be ink.

Referring to FIG. 3, after the completion of the touch circuit 2 and the black matrix 3 on the glass substrate 1, an upper lamination film 4 and a lower lamination film 5 are respectively attached to the operation surface 11 and the circuit layout surface 12 of the glass substrate 1. The upper lamination film 4 and the lower lamination film 5 are made of materials that are resistant acid corrosion in order to protect glass surfaces from damage of scratching and to provide etch protection to the glass in the subsequent operations.

After completion of the film attachment, an edge grinding operation may be applied to the edge 13 of the glass substrate 1 in order to remove irregularity or micro cracks formed during cutting the edge 13 of the glass substrate 1. It is also possible, if desired, to drill holes at selected sites at this moment. Further, a strengthening treatment may be applied to the glass substrate 1 to provide the glass substrate 1 with a desired strength for a final product.

After the above optional operations, the edge 13 of the glass substrate 1 is subjected to etching. The etching helps remove the micro cracks of the edge 13 of the glass substrate 1 that survive the edge grinding operation.

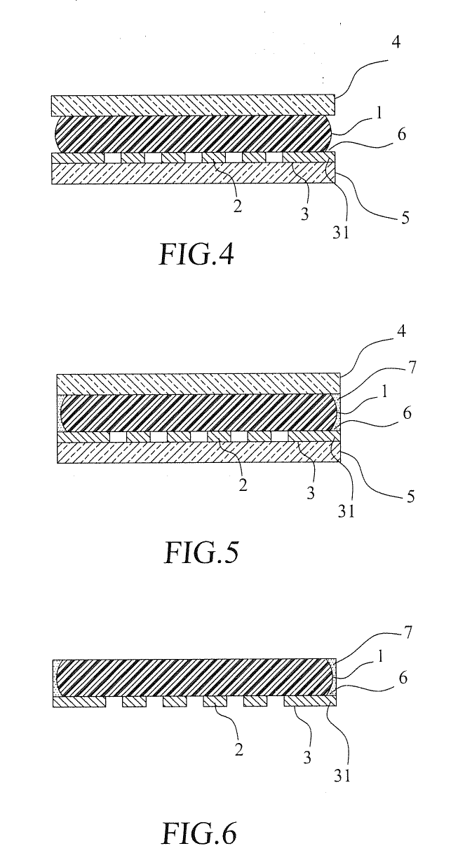

Referring to FIG. 4, a cross-sectional view is given to show the edge 13 of the glass substrate 1 after the etching. As shown, in this etching process, a highly corrosive chemical agent, such as hydrofluoric acid (HF) solution, is used to perform the etching operation.

After the edge of the glass substrate 1 has been kept in the chemical agent for a period of time for etching, a recessed portion 6 is formed at an interface between the edge 13 of the glass substrate 1 and the black matrix 3, whereby the black matrix 3 forms a suspending section 31 corresponding to the recessed portion 6. If no proper structure is provided for overcoming an issue caused by the recessed portion 6 and the suspending section 31 of the black matrix 3, the black matrix 3 may get deformed and detached along with the lower lamination film 5 during a subsequent film peeling operation or peeling of the black matrix 3 may result after a long term use.

Referring to FIG. 5, to prevent the exposed portion of the black matrix 3 from the potential risks of deformation, peeling, and damage, the present invention proposes to first form a structure support section 7 at the interface between the edge of the glass substrate 1 and the black matrix 3 before peeling of the upper lamination film 4 and the lower lamination film 5 is conducted so that the structure support section 7 fills up the recessed portion 6 between the edge of the glass substrate 1 and the black matrix 3. The structure support section 7 helps support and hold the suspending section 31 of the black matrix 3 on the circuit layout surface 12 of the glass substrate 1.

The structure support section 7 can be made of one of acrylic glue, silicone, polyurethane glue, and thermosetting glue and after the material that makes the structure support section 7 gets cured, an effect of supporting and protecting the black matrix 3 can be achieved at the recessed portion 6 along the periphery of the glass substrate 1.

Referring to FIG. 6, after the formation of the structure support section 7 according to the present invention, the upper lamination film 4 and the lower lamination film 5 can be respectively peeled off the operation surface 11 and the circuit layout surface 12 of the glass substrate 1.

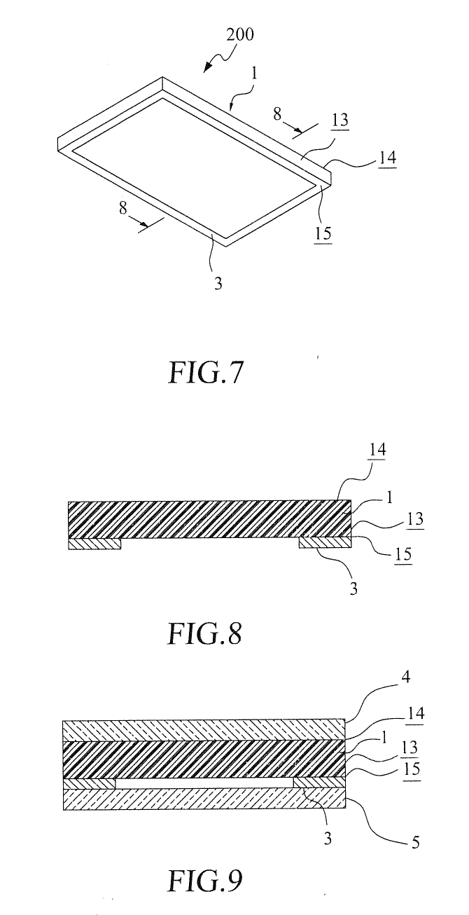

Referring to FIG. 7, a perspective view is given to illustrate a second embodiment of the present invention that is applicable to a glass panel 200 of a screen. FIG. 8 shows a cross-sectional view taken along line 8-8 of FIG. 7. The second embodiment of the present invention has a structure that is substantially similar to that of the first embodiment and identical components/parts are designated with the same reference numerals. In the second embodiment, a glass substrate 1 comprises a first surface 14 and a second surface 15. The glass substrate 1 can be used as a glass panel 200 of a screen. In other words, no touch circuit is laid on the second surface 15 of the glass substrate 1 and only a black matrix 3 is formed thereon in such a way that an outer edge of the black matrix 3 is substantially aligned with an edge 13 of the glass substrate 1.

After the completion of the black matrix 3 on the glass substrate 1 (as shown in FIG. 8), an upper lamination film 4 and a lower lamination film 5 are respectively attached to the first surface 14 and the second surface 15 of the glass substrate 1 (as shown in FIG. 9).

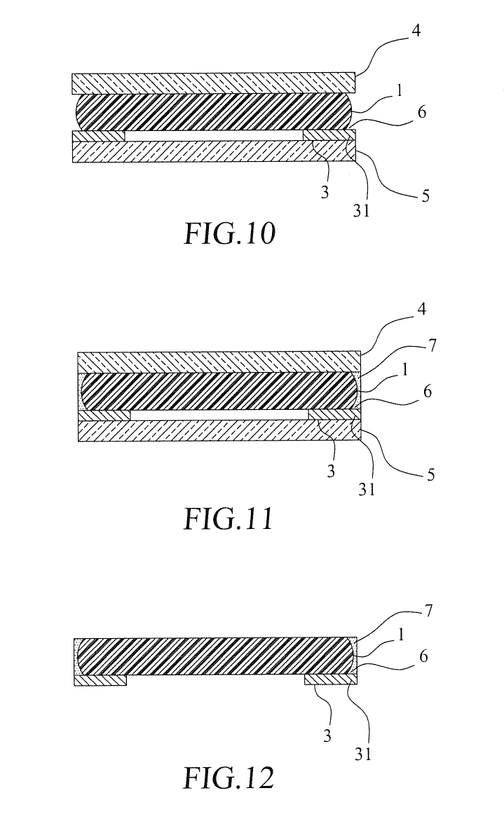

After completion of the film attachment, the edge 13 of the glass substrate 1 is subjected to etching and a recessed portion 6 may be formed at an interface between the edge 13 of the glass substrate 1 and the black matrix 3 (as shown in FIG. 10), whereby the black matrix 3 forms a suspending section 31 corresponding to the recessed portion 6.

Then, a structure support section 7 is formed at the interface between the edge of the glass substrate 1 and the black matrix 3 (as shown in FIG. 11) in such a way that the structure support section 7 fills up the recessed portion 6 between the edge of the glass substrate 1 and the black matrix 3. The structure support section 7 helps support and hold the suspending section 31 of the black matrix 3 on the second surface 15 of the glass substrate 1.

After the formation of the structure support section 7, the upper lamination film 4 and the lower lamination film 5 can be respectively peeled off the first surface 14 and the second surface 15 of the glass substrate 1 (as shown in FIG. 12).

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A glass substrate adapted to serve as a glass touch panel, having an operation surface and a circuit layout surface, the circuit layout surface comprising a touch circuit formed thereon, the glass substrate being, comprising:
a black matrix, which is formed on the circuit layout surface of the glass substrate in such a way that an outer edge of the black matrix is substantially aligned with an edge of the glass substrate, the edge of the glass substrate being subjected to etching so that a recessed portion is formed in the edge of the glass substrate and the black matrix forms a suspending section corresponding to the recessed portion: and
a structure support section being formed to fill up the recessed portion so that the structure support section supports and holds the suspending section of the black matrix on the circuit layout surface of the glass substrate.

2. The glass substrate as claimed in claim 1, wherein the structure support section is made of a material selected from one of acrylic glue, silicone, polyurethane glue, and thermosetting glue.

3. The glass substrate as claimed in claim 1, wherein the glass substrate is formed of one of transparent glass and transparent plastics.

4. The glass substrate as claimed in claim 1, wherein the operation surface of the glass substrate comprises an upper lamination film attached thereto.

5. The glass substrate as claimed in claim 1, wherein the circuit layout surface of the glass substrate comprises a lower lamination film attached thereto.

6. A glass substrate adapted to serve as a glass panel of a screen, having a first surface and a second surface, comprising:
a black matrix, which is formed on the second surface of the glass substrate in such a way that an outer edge of the black matrix is substantially aligned with an edge of the glass substrate, the edge of the glass substrate being subjected to etching so that a recessed portion is formed in the edge of the glass substrate and the black matrix forms a suspending section corresponding to the recessed portion; and
a structure support section being formed to fill up the recessed portion so that the structure support section supports and holds the suspending section of the black matrix on the second surface of the glass substrate.

7. The glass substrate as claimed in claim 6, wherein the structure support section is made of a material selected from one of acrylic glue, silicone, polyurethane glue, and thermosetting glue.

8. The glass substrate as claimed in claim 6, wherein the glass substrate is formed of one of transparent glass and transparent plastics.

9. The glass substrate as claimed in claim 6, wherein the first surface of the glass substrate comprises an upper lamination film attached thereto.

10. The glass substrate as claimed in claim 6, wherein the second surface of the glass substrate comprises a lower lamination film attached thereto.
